(19) United States
(12) Patent Application Publication
(10) Pub. No.: US 2005/0201548 A1
(43) Pub. Date: Sep. 15, 2005

(54) Telephone interface for mask

(76) Inventors: Joseph Birli, Munson, OH (US); Frank Torrieri, Perry, OH (US); Dan Zimet, South Euclid, OH (US); Mike Krnc, Medina, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/078,569

(22) Filed: Mar. 11, 2005

Related U.S. Application Data
(60) Provisional application No. 60/552,775, filed on Mar. 12, 2004.

(51) Int. Cl. H04M 1/00; H04M 9/00

(52) U.S. Cl. 379/387.01; 379/388.05

(57) ABSTRACT

A telephone interface unit enables a user of a personal protection device, such as a mask, to speak and hear over a standard telephone, without removing the personal protection device.

### RELATED APPLICATION

This application claims the benefit of the filing date of U.S. application Ser. No. 60/552,775, filed Mar. 12, 2004, the entire disclosure of which is incorporated by reference.

### BACKGROUND OF THE INVENTION

Personal protections devices, including hoods and masks, are worn to protect against smoke or chemical or biological agents. The mask seals against the face of the user. Clean air is provided to the user through an air connection.

The device covers the user's mouth so that the user's voice can not conveniently be directed into a telephone handset and still be intelligible. Therefore, it may be difficult or impossible for a user of such a personal protection device to be able to communicate with others by telephone, without having to disturb the seal.

### SUMMARY OF THE INVENTION

In accordance with the present invention, a user of a personal protection device, such as a mask, can speak and hear over a standard telephone, without removing the mask.

### BRIEF DESCRIPTION OF THE DRAWINGS

The foregoing and other features of the invention will become apparent to one of ordinary skill in the art to which the invention pertains, from a reading of the following description together with the accompanying drawings, in which:

FIG. 1 is a front view of a personal protection device with a telephone interface unit; and

FIG. 2 is an enlarged exploded sectional view of portions of the telephone interface unit.

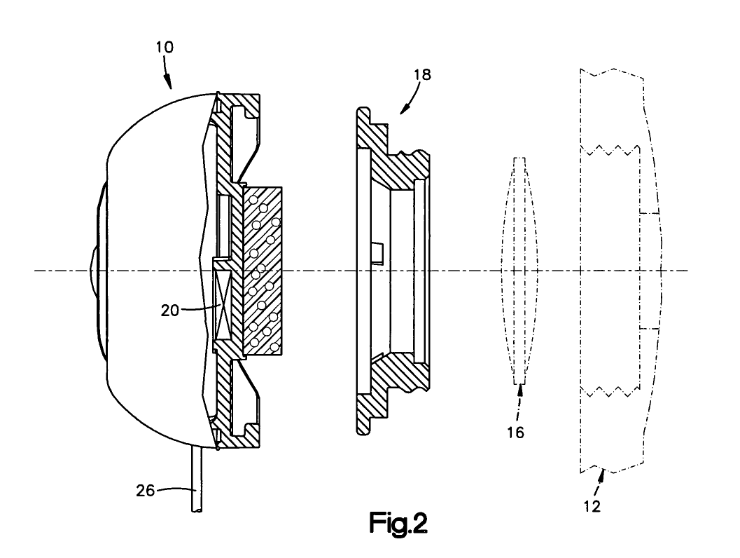

### DESCRIPTION OF THE INVENTION

The present invention relates to a personal protection device, such as a mask and to a way in which user of a personal protection device, such as a mask, can speak and hear over a standard telephone, without removing the mask.

In accordance with the present invention, a mask user can speak and hear over a standard telephone, without removing the mask. The invention includes a telephone interface unit 10, described below, that is mounted on a mask for this purpose. The interface unit 10 is but one embodiment, or variation, of the invention. Many aspects of the particular interface unit that that is described below can be changed, or varied, with the unit still falling within the scope of the invention. Some of these variations and changes are discussed below, following the description of the interface unit 10.

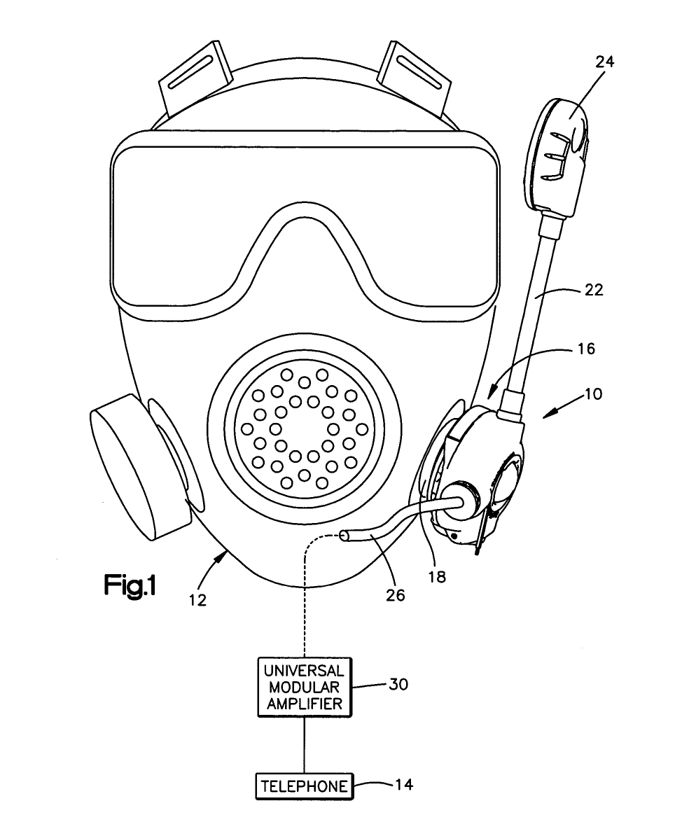

FIG. 1 illustrates a mask 12 of the type that might be worn, for example, to protect against chemical or biological agents. The mask 12 seals against the face of the user. Clean air is provided to the user through an air connection. The invention is usable with other types of masks, of course.

It is desired that the user be able to communicate with others by telephone when wearing the mask 12, without having to disturb the mask seal, for example, in an area that is or may be contaminated by a chemical or biological agent. This can be difficult or impossible if, as is illustrated, the mask 12 covers the user's mouth so that the user's voice can not conveniently be directed into a telephone handset and still be intelligible.

In accordance with the present invention, a mask user can speak and hear over a standard telephone 14, without removing the mask 12.

The mask 12 includes a mechanical speaker diaphragm 16 that is airtight. The invention includes a ring 18 extending around the speaker diaphragm 16. The mask 12 may be supplied by the mask manufacturer with a ring holding the speaker diaphragm 16 in place. The ring that is supplied by the mask manufacturer can be replaced with a ring 18 having external connection capability, so that the ring 18 may support an external device as well as secure the diaphragm 16 in place on the mask 12 itself.

The telephone interface unit 10 is connected to the ring 18. By virtue of this connection, the interface unit 10 can be attached to and removed from the mask 12, without disturbing the integrity of the mask seal.

The telephone interface unit 10 includes a transducer in the form of a microphone 20 that provides an electrical output signal indicative of the movement of the diaphragm 16. The telephone interface unit 10 also includes a boom 22 that supports an ear speaker 24 positioned adjacent the user's ear when the interface unit is mounted on the mask 12. The ear speaker 24, boom 22, and microphone 20 are all one unit. The interface unit 10 can be self-powered or can use external power.

A cable 26 extends from the interface unit 10. The cable 26 may be connected directly to the telephone 14 or with a headset interface box or universal modular amplifier 30. The universal modular amplifier 30 is connected with the telephone 14. The universal modular amplifier 30 is adapted to make electrical connections between the mask interface unit 10 and the telephone 14. One example of a universal modular amplifier 30 that can be used is a Plantronics brand interface box Model M-12, available from Plantronics, Inc., and described on the company's Web site at www.plantronics.com.

When used, the universal modular amplifier 30 is connected to the existing telephone 14 in place of the existing telephone's handset and acts as a junction box: the existing handset of the existing telephone is plugged into the interface box, and the telephone interface unit 10 of the present invention is also plugged into the interface box, in place of a headset.

The universal modular amplifier 30 provides full duplex communication over the cable 26 between the telephone 14 and the mask interface unit 10. As a result, the user of the mask 12 is able to communicate via standard telephone lines (use a telephone in a normal manner), without having to remove the mask. The user's outgoing voice signal is picked up outside the air-tight area of the mask 12 by the microphone 20, and may be filtered or otherwise enhanced. A phone message that is incoming over the telephone 14 is delivered to the user's ear by the ear speaker 24 without interfering with a protective hood that the user may be wearing, or any other over-garment. The interface unit 10 can easily be removed from the mask 12 in seconds without disconnecting any wires. The interface unit 10 preferably includes a ratchet mechanism that allows the user to adjust speaker position without inadvertently loosening the mask's side voicemitter lock ring and thus safeguards the integrity of the mask's face seal.

As noted above, the interface unit 10 described above is but one embodiment, or variation, of the invention. Many aspects of the interface unit 10 can be changed, or varied, with the unit still falling within the scope of the invention.

For example, the invention is not limited to masks with a diaphragm retaining ring for retaining a mechanical speaker diaphragm. The invention can be used with masks that have a different mechanism for holding the diaphragm, or with masks that utilize an internal microphone. More broadly, the interface unit need not be mounted to the ring itself.

As another example, the ear speaker and boom assembly can be replaced with an earbud, or with an earmic that serves as both a microphone and a speaker. The microphone can be replaced with a throat microphone or a bone conduction microphone.

As a further example, the telephone interface unit may communicate wirelessly between mask and telephone. A small mask-mounted assembly, including a microphone, ear speaker, and transceiver, can communicate wirelessly with a small transceiver connected either to the universal modular amplifier or directly to the telephone. Other examples of modifications and variations will be apparent to those of ordinary skill in the art, and are intended to be covered within the scope of the invention.

1. An interface unit for use with a personal protection device and a telephone;
the interface unit having a mounting portion adapted for mounting on the personal protection device; and
the interface unit including a microphone and a speaker adapted for use by a wearer of the personal protection device when the interface unit is mounted on the personal protection device;
the interface unit having a duplex output adapted for electrical connection with the telephone.

2. Apparatus as set forth in claim 1 wherein the mounting portion of the interface unit is adapted for mounting over a speaker diaphragm.

3. Apparatus as set forth in claim 1 wherein the output of the interface unit is a cable adapted for duplex connection with the amplifier.

4. Apparatus as set forth in claim 1 wherein the interface unit includes a microphone that provides an electrical output signal that is indicative of the movement of a speaker diaphragm on the device.

5. Apparatus as set forth in claim 1 wherein the interface unit includes an ear speaker on a boom.

6. Apparatus as set forth in claim 1 wherein the interface unit includes an earbud.

7. Apparatus as set forth in claim 1 wherein the interface unit includes an earmic.

8. Apparatus as set forth in claim 1 wherein the interface unit is self-powered.

9. Apparatus as set forth in claim 1 wherein the output of the interface unit is a wireless connection for transmission to an external device, such as an amplifier.

10. Apparatus comprising:
a personal protective device;
an interface unit for mounting on the device; and
an amplifier for connecting the interface unit with a telephone;
the interface unit including a microphone and a speaker adapted for use by a wearer of the device when the interface unit is mounted on the device;
the interface unit also having an output for connection with the amplifier.

11. Apparatus as set forth in claim 10 wherein the amplifier is operative to provide full duplex communication between the interface unit and the telephone.

12. Apparatus as set forth in claim 10 wherein the personal protective device is a mask.

13. Apparatus as set forth in claim 12 wherein the mask has a mechanical speaker diaphragm and the interface unit is mounted over the speaker diaphragm.

14. Apparatus as set forth in claim 13 wherein the mask includes a ring holding the speaker diaphragm in place on the mask, the ring having an external connection capability for supporting the interface unit on the mask.

15. Apparatus as set forth in claim 10 wherein the output of the interface unit is a duplex cable adapted for connection with the amplifier.

16. Apparatus as set forth in claim 10 wherein the amplifier is a universal modular amplifier.

17. Apparatus as set forth in claim 10 wherein the interface unit includes a microphone that provides an electrical output signal that is indicative of the movement of a speaker diaphragm on the device.

18. Apparatus as set forth in claim 10 wherein the interface unit includes an ear speaker on a boom.

19. Apparatus as set forth in claim 10 wherein the interface unit includes an earbud.

20. Apparatus as set forth in claim 10 wherein the interface unit includes an earmic.

21. Apparatus as set forth in claim 10 wherein the interface unit is self- powered.

22. Apparatus as set forth in claim 10 wherein the output of the interface unit is a wireless connection for transmission to the amplifier.
